(19) United States
(12) Patent Application Publication
(10) Pub. No.: US 2002/0099815 A1
(43) Pub. Date: Jul. 25, 2002

(54) Event driven modular controller method and apparatus

(76) Inventors: Ranjan Chatterjee, Hoffman Estates, IL (US); Greg Rahn, Sugar Grove, IL (US); Keven Lee Kent, Woodstock, IL (US)

Correspondence Address: MOTOROLA, INC., 1303 EAST ALGONQUIN ROAD, IL01/3RD, SCHAUMBURG, IL, 60196

(21) Appl. No.: 09/771,128

(22) Filed: Jan. 25, 2001

(51) Int. Cl. G06F 15/173

(52) U.S. Cl. 709/224

(57) ABSTRACT

A method and apparatus for a dynamic event driven modular controller apparatus (102) receiving at least one signal (118), having a filter (202) to identify a predetermined portion of the received signal as an event and a controller (110) that executes a user defined action stored in the event action list (210) resulting in the generation of a plurality of metrics. The plurality of metrics are stored in a storage device (112).

### FIELD OF THE INVENTION

The present invention relates generally to collection of metrics and, specifically to, collection and analysis of metrics from numerous devices.

### BACKGROUND OF THE INVENTION

As automation becomes more prevalent in industry, the ability of assembly machines and other devices to report events become more common. But, different types of machines and devices often have a unique set of reportable events based on equipment type and manufacturer. For example, an assembly line for producing consumer electronics is often comprised of multiple insertion machines and soldering machines. Each machine generates events that must be individually collected and examined in order to identify production inefficiencies.

Accordingly, there is a need in the art for an apparatus and method for enabling the collection and compellation of event data from diverse sources in order to produce quality metrics.

### BRIEF DESCRIPTION OF THE DRAWINGS

FIG. 1 is a block diagram of a dynamic event driven modular controller connected to multiple applications in accordance with an embodiment of the invention;

FIG. 2 is a more detailed block diagram of the dynamic event driven modular controller in accordance with an embodiment of the invention;

FIG. 3 is a flow chart showing the method steps for the dynamic event driven modular controller in accordance with an embodiment of the invention; and

FIG. 4 is a flow chart showing the method steps for an assembly line dynamic event driven modular controller in accordance with an embodiment of the invention.

### DETAILED DESCRIPTION

The problem of collection of event data from diverse sources and production of quality metrics is solved by a dynamic event driven modular controller. The dynamic event driven modular controller uses a number of user-defined filters to identify events received from the multiple applications. The identified events are further used to generate a plurality of metrics that are graphically displayed in an offline mode and in a real-time mode.

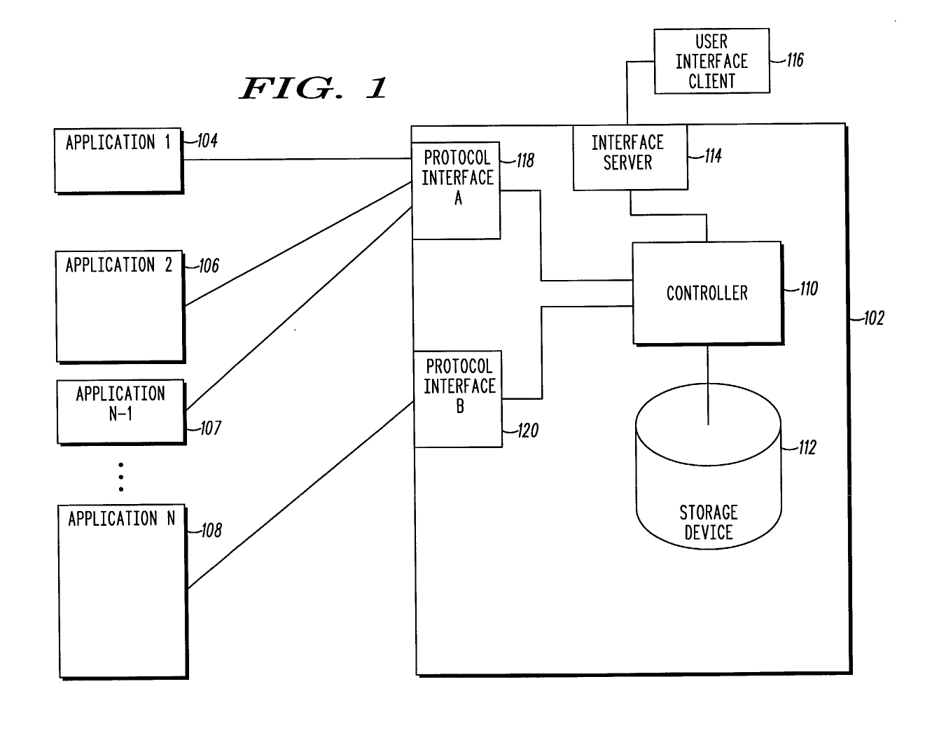

In FIG. 1, a block diagram of a dynamic event driven modular controller 102 connected to multiple applications 104-108 is shown. The dynamic event driven modular controller 102 having controller 110 coupled to a storage device 112 interface server 114, a protocol interface “A” and a protocol interface “B”. The Interface server 114 is coupled to a user interface client 116 and the controller 110. The protocol interface “A” 118 is coupled to the controller 110, application one 104, application two 106. The protocol interface “B” is coupled to the controller 110 and application “N” 108.

Application one 104 generates predetermined events, such as out-of-service, off-line, jam, service required, processing halted, manual out-of-service. The predetermined events are sent to the dynamic event driven modular controller 102 via the protocol interface “A”. The protocol interface “A” is configured to transmit and receive the [WHAT EVER] (GEM) protocol carrying event data from the applications 104-108. In the current embodiment, the protocol interface “A” 118 and protocol interface “B” 120 poll applications 104-108 for event e. In an alternate embodiment, protocol interface “A” 118 and protocol interface “B” 120 simple receive messages from applications 104-108 at any time. In yet another embodiment, a combination of polling of applications and receiving messages at any time is employed by the protocol interface “A” 118 and protocol interface “B” 120. Additionally, other protocols, such as [WHAT EVER], or other suitable communication protocols utilized by a machine, may selective be used in addition to GEM (Generic Equipment Model) or in place of the GEM protocol in alternate embodiments.

The protocol interface “A” 118 and protocol interface “B” 120 extract the receive the event data contained in the protocol. The event data is sent from the protocol interface “A” 118 and protocol interface “B” 120 to the controller 110.

The controller 110 is coupled to a memory (not shown in FIG. 1), such as random access memory (RAM, DRAM, SRAM), read only memory (ROM), or a combination of memory types. Examples of controllers are microprocessors, micro-controllers, application specific integrated circuits, discrete logic circuits functioning as a controller and analog circuits functioning as a controller. The controller 110 identifies the event and saves it in a database located in the storage device 112. If a real time display has been selected at the user interface client 116, the event data is formatted and sent to the user interface client 116 via the interface server 114.

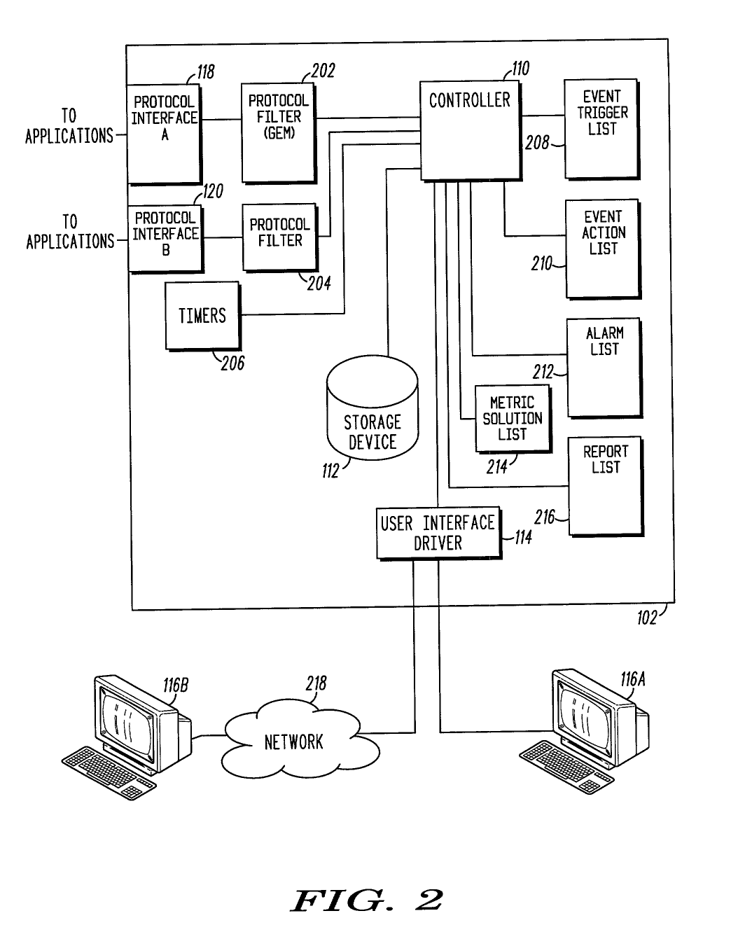

Turning to FIG. 2, a more detailed block diagram of the dynamic event driven modular controller 102 is shown. The dynamic event driven modular controller 102 is coupled directly to a terminal 116A and via a network 218 to another terminal 116B. The dynamic event driven modular controller 102 having a controller 110 is coupled to the user interface driver 114, the storage device 112, an event trigger list 208, an event action list 210, an event alarm list 212, a report list 216, a metric collection list 214, timers 206, a GEM protocol filter 202, and a machine protocol filter 204. The protocol Interface “A” is coupled applications 104-106, FIG. 1, and the GEM protocol filter 202, FIG. 2. The protocol interface “B” 120 is coupled to application 107, FIG. 1, and the machine protocol filter 204, FIG. 2.

The dynamic event driven modular controller 102 receives event information from the applications 104-107, FIG. 1, at the protocol interface “A” 118, FIG. 2, and from application 108, FIG. 2, at protocol interface “B” 120, FIG. 2. The protocol signal received by protocol interface “A” 118 is decoded and sent to the GEM protocol filter 202. The GEM protocol filter 202 identifies the GEM events contained in the received protocol signal. Similarly, the received encoded signal at protocol interface “B” 120 is decoded and sent to the machine protocol filter 204 that identifies the events.

The controller 110 receives the machine protocol and GEM events from protocol filters 202 and 204. The received events are compared to events that are present in an event trigger list 208 stored in memory. The event trigger list 208 is created by associating an event with an action located in the event action list 210.

An event in the event trigger list 208 is associated with an alarm located in the alarm list 212. The associations of alarms and actions are customizable to each application 104-108, FIG. 1. For example, a production line would have a event actions and alarms to aid in the generation of production metrics and a hospital would use event actions and alarms to generate metrics relating to the conditions of one or more patients.

In the current embodiment, the association of events to event actions and alarms occurs at the user terminals 116A, FIG. 1, and 116B via graphical representations of the event trigger list 208, event action list 210, and alarm list 212. The associations between the lists are accomplished by a drag and drop operation from one list to the other.

For example, an event is dragged to the event action list and dropped. An action definition box is then defined identifying the action to be taken when the event occurs. Alarms are similarly defined. The association can occur by defining the alarm or event action and then dragging the associated identifier to the event trigger list and identifying and event. Additionally other functions, such as copying event actions and alarms, are also supported in the current embodiment. In an alternate embodiment, a text based or combination text and graphics representation on a terminal 116A or 116B is used to display the associations between the events, event actions, and alarms.

If the received event matches an event located in the event trigger list 208, then the controller 110 executes the action specified in the event action list 210. Additionally, the controller 110 generates an alarm if the event or action is identified in the alarm list 212. The generated alarm is then recorded in a database on the storage device 112. If a real time display is active, then the alarm is sent from the controller 110 to the terminals 116A and 116B via the user interface driver 114.

An example of an event action contained in the event action list 210 is starting a timer to measure an application out-of-service time. If a received out-of-service event is in the event trigger list 208, an associated configured event action in the event action list 210 executes the starting of a timer located among a plurality of assignable timer 206. When the appropriate event is identified that is associated with stopping the timer, the controller 110 records the out-of-service time in the storage device and increments an aggregate outage time value in the metric collection list 214.

The metric collection list 214 enables metric data that is collected to statistically processed over user selectable time periods. The time periods can be predefined and grouped together as a report in the report list 216. Thus, any number of stored metrics can be statistically processed and displayed by configuring a report. In addition to the report time period, the type of statistical display is configured, such as a pie chart, bar chart, tab columns, or other text/graphical displays of metric data.

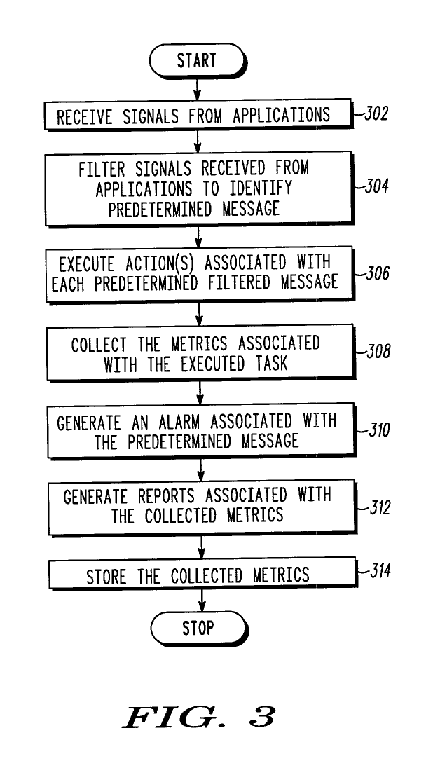

In FIG. 3, a flow chart showing the method steps for the dynamic event driven modular controller is shown. One or more signals are received from applications 104-108, FIG. 1, at the dynamic event driven modular controller 102 in step 302, FIG. 3. In step 304, the received signal is filtered to identify predetermined messages or events. The filter identified messages or events that are present in the event trigger list 208, FIG. 2.

The actions associated with each of the predetermined filtered messages or events in step 306, FIG. 3, are executed as each message or event is identified. The collection of metrics associated with the executed action is accomplished in step 308. In step 310, alarms associated with the identified message or event are generated. In step 312, reports are generated in real time or offline in response to predetermined configuration or query from a terminal 116A or 116B, FIG. 1. The metrics that are collected are stored in the storage device 112 in step 314, FIG. 3.

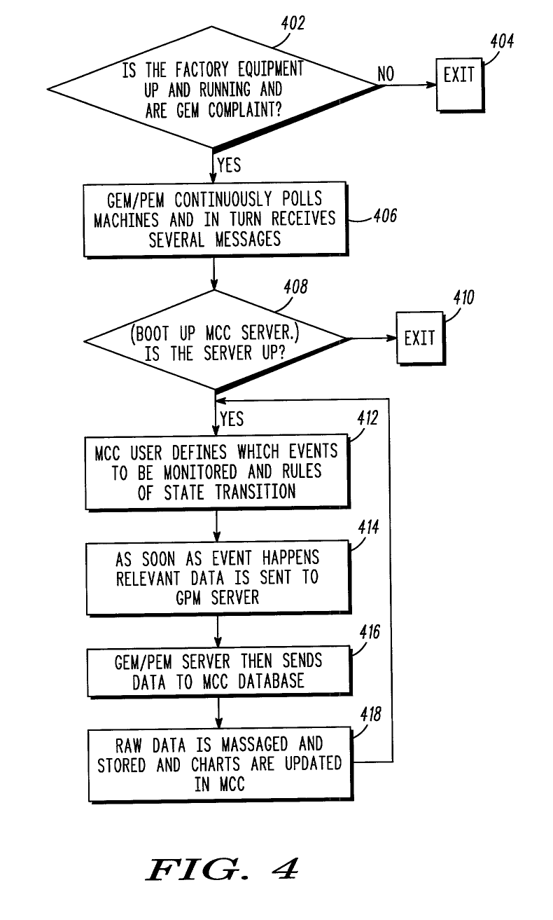

Turning to FIG. 4, a flow chart showing the method steps for an assembly line dynamic event driven modular controller 102, FIG. 1. In step 402, FIG. 4, a determination is made if the factory equipment is up and running with the applications using the GEM protocol. If the factory equipment is down then processing halts at step 404. If in step 402, the factory machines are running, then the dynamic event driven modular controller 102, FIG. 1, continuously polls each machine and in turn receives several messages in step 406, FIG. 4.

In step 408, a determination is made as to the availability of an [WHAT EVER](MCC) server. The current embodiment being a client server architecture having the storage device located on the server and accessed by clients. If the MCC server is unavailable in step 408, then processing halts in step 410. If the MCC server is available in step 408, then in step 412, the user defines which events are to be monitored (placed in the event trigger list 208, FIG. 2) and defines the rules of state transitions (event action list 210 and alarm list 212).

When an identified event is detected in step 414, FIG. 4, the relevant data is sent to a GEM server. The GEM server then sends the data to the MCC server database in step 416. The raw data is then sent via messages to the storage device 112, FIG. 1 and stored charts are updated in step 418. After step 418, step 408 is repeated

The flow diagrams of FIG. 3 and FIG. 4 depicted herein are just exemplary. There may be many variations to these diagrams or the steps (or operations) described therein without departing from the spirit of the invention. For instance, the steps may be performed in a differing order, or steps may be added, deleted or modified. All these variations are considered a part of the claimed invention.

In yet another embodiment, the computer-readable signal-bearing medium comprises a modulated carrier signal transmitted over a network comprising or coupled with a diversity receiver apparatus, for instance, one or more telephone networks, a local area network, the Internet, and wireless network. An exemplary component of such embodiments is a series of computer instructions written in or implemented with any number of programming languages.

While the invention has been particularly shown and described with reference to a particular embodiment, it will be understood by those skilled in the art that various changes in form and details may be made therein without departing from the spirit and scope of the invention and it is intended that all such changes come within the scope of the following claims.

We claim:

1. A method of receiving at least one signal at an event driven controller, comprising the steps of:
identifying a predetermined portion of the at least one signal;
executing a user defined action in response to the predetermined portion of the at least one signal; and
generating a plurality of metrics in response to the user defined action.

2. The method of claim 1, wherein the step of identifying comprises the step of filtering an event identifier from the at least one signal.

3. The method of claim 1, wherein the step of executing comprises the step of assigning a user defined action to the predetermined portion of the at least one signal.

4. The method of claim 3, wherein the step of assigning comprises the step of associating a timer with the predetermined portion of the at least one signal.

5. The method of claim 1, wherein the step of generating a plurality of metrics comprises the step of processing the plurality of metrics in real time.

6. The method of claim 1, wherein the step of generating a plurality of metrics comprises the steps of accessing a data store having a plurality of stored data, and
processing the plurality of meterics over a predetermined time.

7. The method of claim 1 further comprising the step of displaying the plurality of metrics.

8. The method of claim 7, wherein the step of displaying the plurality of metrics comprises the step of generating a predefined graphical representation of at least one metric in the plurality of metrics.

9. The method of claim 8, wherein the step of generating the predefined graphical representation comprises the step of choosing a graph style for the at least one metric.

10. The method of claim 7, wherein the step of displaying comprises the steps of accessing the driven controller from a remote display, and
sending to the remote display a terminal signal having at least one metric.

11. The method of claim 1 0, wherein the step of sending comprises the step of encoding the terminal signal as an internet web signal.

12. An event driven controller apparatus receiving at least one signal, comprising:
a filter that identifies a predetermined portion of the at least one signal; and
a controller for executing a user defined action in response to identification of the predetermined portion of the at least one signal to generate a plurality of metrics.

13. The apparatus of claim 2, wherein the filter identifies an event contained in an event trigger list from the at least one signal.

14. The apparatus of claim 2, wherein the controller associates a user defined action to the predetermined portion of the at least one signal.

15. The apparatus of claim 14, further comprising a timer that the controller associates with a predetermined portion of the at least one signal.

16. The apparatus of claim 12, wherein the controller processes the plurality of metrics in real time.

17. The apparatus of claim 12, further comprising a data storage device having a plurality of stored data indexed by time, wherein the metric controller processes the plurality of stored data indexed by time over a predefined time interval.

18. The apparatus of claim 12 further comprising a display device that displays the plurality of metrics.

19. The apparatus of claim 18, wherein the metric controller formats the plurality of metrics into a predefined graphical representation of at least one metric in the plurality of metrics.

20. A computer usable medium having computer readable program code means embodied therein receiving at least one signal, the computer readable program code, comprising:
means having computer readable program code for identifying a predetermined portion of the at least one signal,
means having computer readable program code for executing a user defined action in response to the predetermined portion of the at least one signal, and
means having computer readable program code generating a plurality of metrics in response to the user defined action.

21. The computer usable medium of claim 20 further comprising means having computer readable program code for filtering an event identifier from the at least one signal.

22. The computer usable medium of claim 20 further comprising means having computer readable program code for assigning a user defined action to the predetermined portion of the at least one signal.

23. The computer usable medium of claim 22 further comprising means having computer readable program code for associating a timer with the predetermined portion of the at least one signal.

24. The computer usable medium of claim 20 further comprising means having computer readable program code for processing the plurality of metrics in real time.

25. The computer usable medium of claim 20 further comprising means having computer readable program code for processing the plurality of metrics over a predetermined time by accessing a data store having a plurality of stored data.

26. The computer usable medium of claim 20 further comprising means having computer readable program code for displaying the plurality of metrics.

27. The computer usable medium of claim 26 further comprising means having computer readable program code for generating a predefined graphical representation of at least one metric in the plurality of metrics.

28. The computer usable medium of claim 27 further comprising means having computer readable program code for choosing a graph style for the at least one metric.

29. The computer usable medium of claim 26 further comprising means having computer readable program code for accessing the plurality of metrics from a remote display, and
means having computer readable program code for sending to the remote display a terminal signal having at least one metric.

30. The computer usable medium of claim 29 further comprising means having computer readable program code for encoding the terminal signal as an internet web signal.
